(19) United States
(12) Patent Application Publication
(10) Pub. No.: US 2023/0350009 A1
(43) Pub. Date: Nov. 2, 2023

(54) SIGNAL PROCESSOR, SIGNAL PROCESSING METHOD, AND RADAR DEVICE

(71) Applicant: Mitsubishi Electric Corporation, Tokyo (JP)

(72) Inventor: Satoshi KAGEME, Tokyo (JP)

(73) Assignee: Mitsubishi Electric Corporation, Tokyo (JP)

(21) Appl. No.: 18/219,271

(22) Filed: Jul. 7, 2023

Related U.S. Application Data
(63) Continuation of application No. PCT/JP2021/008582, filed on Mar. 5, 2021.

(51) Int. Cl. G01S 7/292; G01S 7/288

(52) U.S. Cl. CPC G01S 7/2926; G01S 7/2883

(57) ABSTRACT

A signal processor is configured to include: a high-order phase linearizing unit to acquire an input reception signal of a reflected wave from a target to be detected, and raise a sampling number of the input reception signal to power by using an order of a high-order component included in the input reception signal as a power index; and a high-order coherent integrating unit to perform coherent integration of the reception signal having the sampling number raised to the power by the high-order phase linearizing unit.

### CROSS REFERENCE TO RELATED APPLICATIONS

This application is a Continuation of PCT International Application No. PCT/JP2021/008582 filed on Mar. 5, 2021, which is hereby expressly incorporated by reference into the present application.

### TECHNICAL FIELD

The present disclosure relates to a signal processor, a signal processing method, and a radar device.

### BACKGROUND ART

There is a radar device (hereinafter, referred to as a “conventional radar device”) that detects a target by receiving a reflected wave from the target to be detected and performing signal processing on a reception signal of the reflected wave. The conventional radar device coherently integrates the reception signal of the reflected wave by, for example, performing Fourier transform on the reception signal in order to increase a signal-to-noise ratio of the reception signal and improve target detection performance.

When the speed of the target to be detected is constant, the phase of the reflected wave linearly changes with the lapse of time. If the change in phase is linear, even in a case where the conventional radar device coherently integrates the reception signal, there is almost no integration loss associated with the coherent integration.

On the other hand, when the speed of the target to be detected is not constant and the target to be detected performs an acceleration motion, the phase of the reflected wave changes nonlinearly with the lapse of time. If the change in phase is nonlinear, the conventional radar device coherently integrating a reception signal may cause a large integration loss. Therefore, in the conventional radar device, when the target to be detected performs an acceleration motion, the target detection performance may deteriorate.

Patent Literature 1 discloses a detection device capable of improving target detection performance even when a target to be detected performs an acceleration motion. The detection device includes an acceleration assumption unit that sets assumption of acceleration, a compensation unit that compensates for a phase of a reception signal of a reflected wave by using the acceleration assumed by the acceleration assumption unit, and a Fourier transform unit that performs coherent integration of the reception signal after phase compensation by performing Fourier transform on the reception signal after phase compensation by the compensation unit.

### CITATION LIST

### Patent Literature

Patent Literature 1: JP 2014-74602 A

### SUMMARY OF INVENTION

### Technical Problem

In the detection device disclosed in Patent Literature 1, if the acceleration assumed by the acceleration assumption unit does not match the acceleration of a target to be detected, the Fourier transform unit coherently integrating the reception signal after the phase compensation by the compensation unit may cause an integration loss. Therefore, in the detection device, there is a problem that the target detection performance may deteriorate if the acceleration assumed by the acceleration assumption unit does not match the acceleration of the target to be detected.

The present disclosure has been made to solve the problems as described above, and an object thereof is to obtain a signal processor and a signal processing method capable of suppressing the occurrence of an integration loss associated with coherent integration without assuming target acceleration.

### Solution to Problem

A signal processor according to the present disclosure includes processing circuitry to acquire an input reception signal of a reflected wave from a target to be detected, and raise a sampling number of the input reception signal to power by using an order of a high-order component included in the input reception signal as a power index, and to perform coherent integration of the reception signal having the sampling number raised to the power.

### Advantageous Effects of Invention

According to the present disclosure, it is possible to suppress occurrence of an integration loss associated with coherent integration without assuming target acceleration.

### BRIEF DESCRIPTION OF DRAWINGS

FIG. 1 is a configuration diagram illustrating a radar device 1 including a signal processor 30 according to a first embodiment.

FIG. 2 is a hardware configuration diagram illustrating hardware of the signal processor 30 according to the first embodiment.

FIG. 3 is a hardware configuration diagram of a computer in a case where the signal processor 30 is implemented by software, firmware, or the like.

FIG. 4 is a flowchart illustrating a processing procedure performed in the radar device 1 illustrated in FIG. 1.

FIG. 5 is a flowchart illustrating a processing procedure performed in a transmission unit 10 illustrated in FIG. 1.

FIG. 6 is a flowchart illustrating a processing procedure performed in a reception unit 20 illustrated in FIG. 1.

FIG. 7 is a flowchart illustrating a signal processing method which is a processing procedure performed in the signal processor 30 illustrated in FIG. 1.

FIG. 8 is an explanatory diagram illustrating a relative speed in a case where a relative acceleration changes and a relative speed in a case where a relative acceleration does not change during an integration time T_{cpi} of a reception video signal V(m).

FIG. 9 is an explanatory diagram illustrating an integration loss generated in a case where a relative acceleration changes during an integration time T_{cpi} of a reception video signal V(m).

FIG. 10 is an explanatory diagram illustrating a temporal change of a phase in a case where a relative acceleration does not change and a temporal change of a phase in a case where the relative acceleration changes.

FIG. 11A is an explanatory diagram illustrating a reception video signal Vᵥ(m) after phase change suppression by a low-order compensating unit 31, and FIG. 11B is an explanatory diagram illustrating a reception video signal Vᵥ′(m′) after phase linearization by a high-order phase linearizing unit 32 when Nₘᵤₗₜᵢ=2.

FIG. 12A is an explanatory diagram illustrating a relationship between a sampling number m and a phase of a reception video signal Vᵥ(m) after phase change suppression by the low-order compensating unit 31, and FIG. 12B is an explanatory diagram illustrating a relationship between a sampling number m′ and a phase of a reception video signal Vᵥ′(m′) after phase linearization by the high-order phase linearizing unit 32.

FIG. 13 is an explanatory diagram illustrating a reception video signal f_{v,h}(m′_{fft}) after coherent integration.

FIG. 14 is a configuration diagram illustrating a radar device 1 including a signal processor 30 according to a second embodiment.

FIG. 15 is a hardware configuration diagram illustrating hardware of the signal processor 30 according to the second embodiment.

FIG. 16A is an explanatory diagram illustrating a reception video signal V(m) output from an A/D converter 23, and FIG. 16B is an explanatory diagram illustrating N partialized reception video signals Vₛ(n,m) extracted by a low-order frequency domain converting unit 35.

FIG. 17 is an explanatory diagram illustrating a frequency domain signal f_{L}(n,m_{fft}) and a frequency domain signal in a case where a reception video signal V(m) output from the A/D converter 23 is converted into a frequency domain signal.

FIG. 18 is an explanatory diagram illustrating a signal f_{L,H}(k_{fft},m_{fft}) after coherent integration by a high-order coherent integrating unit 37.

FIG. 19 is an explanatory diagram illustrating CFAR processing on the signal f_{L,H}(k_{fft},m_{fft}) after coherent integration.

FIG. 20 is a flowchart illustrating a processing procedure when a high-order component of a tertiary component or higher of time is coherently integrated.

FIG. 21A is an explanatory diagram illustrating a signal after primary frequency domain conversion, FIG. 21B is an explanatory diagram illustrating a signal after secondary phase linearization, FIG. 21C is an explanatory diagram illustrating a signal before secondary frequency domain conversion, FIG. 21D is an explanatory diagram illustrating a signal after secondary frequency domain conversion, FIG. 21E is an explanatory diagram illustrating a signal after tertiary phase linearization, and FIG. 21F is an explanatory diagram illustrating a signal after coherent integration.

### DESCRIPTION OF EMBODIMENTS

In order to explain the present disclosure in more detail, some modes for carrying out the present disclosure will be described below with reference to the accompanying drawings.

### First Embodiment

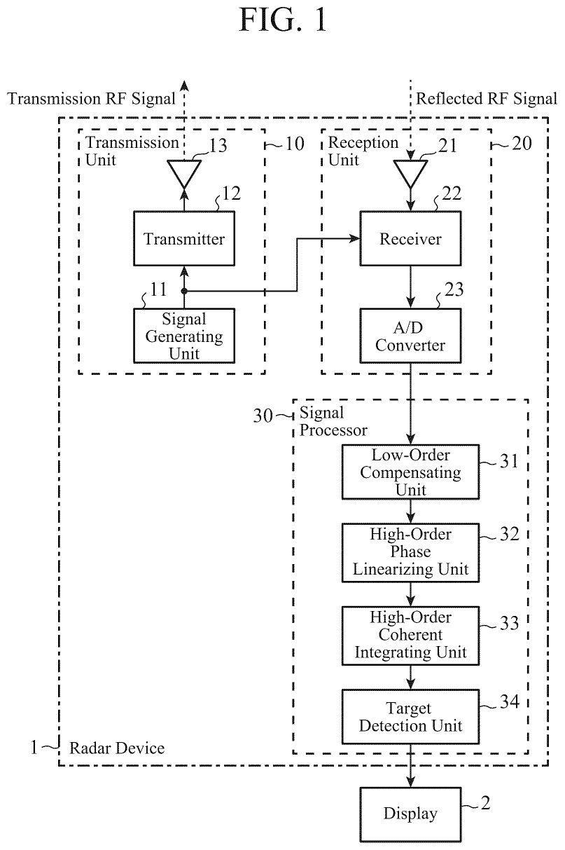

FIG. 1 is a configuration diagram illustrating a radar device 1 including a signal processor 30 according to a first embodiment.

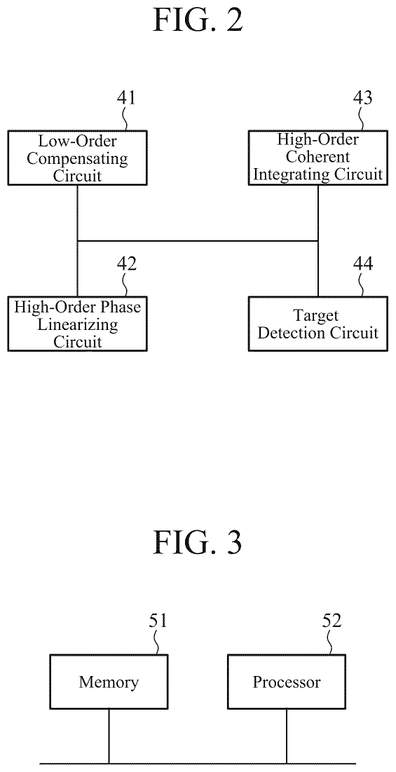

FIG. 2 is a hardware configuration diagram illustrating hardware of the signal processor 30 according to the first embodiment.

The radar device 1 illustrated in FIG. 1 includes a transmission unit 10, a reception unit 20, and the signal processor 30.

The radar device 1 receives a reflected wave from a target to be detected, detects the target by performing signal processing on a reception signal of the reflected wave, and outputs the detection result of the target to a display 2 to be described later.

The radar device 1 illustrated in FIG. 1 includes the transmission unit 10. However, this is merely an example, and the transmission unit 10 may be provided in a device different from the radar device 1 illustrated in FIG. 1.

The display 2 displays the detection result of the target output from the radar device 1 on the display. The target detection result includes a target speed, a target acceleration, and the like.

The transmission unit 10 includes a signal generating unit 11, a transmitter 12, and a transmission antenna 13.

The transmission unit 10 radiates a transmission radio frequency (RF) signal that is an electromagnetic wave into the air.

The signal generating unit 11 generates a transmission signal and outputs the transmission signal to each of the transmitter 12 and a receiver 22 to be described later.

Upon receiving the transmission signal from the signal generating unit 11, the transmitter 12 generates a transmission RF signal from the transmission signal and outputs the transmission RF signal to the transmission antenna 13.

The transmission antenna 13 radiates the transmission RF signal output from the transmitter 12 into the air.

A part of the transmission RF signal radiated from the transmission antenna 13 into the air is reflected by the target to be detected.

In the radar device 1 illustrated in FIG. 1, the transmission unit 10 includes one transmission antenna 13. However, this is merely an example, and the transmission unit 10 may include a plurality of transmission antennas 13, and the plurality of transmission antennas 13 may constitute an array antenna.

The transmission RF signal radiated from the transmission antenna 13 into the air may be a continuous wave, a pulse wave, or a modulated wave.

The reception unit 20 includes a reception antenna 21, a receiver 22, and a digital-to-analog converter (hereinafter, referred to as an “A/D converter”) 23.

The reception unit 20 receives the reflected wave from the target to be detected, and outputs a reception video signal that is a time-series reception signal of the reflected wave to the signal processor 30.

The reception antenna 21 receives a time-series reflected RF signal of the reflected wave from the target to be detected, and outputs the time-series reflected RF signal to the receiver 22.

The receiver 22 generates a time-series reception signal by down-converting the frequency of the reflected RF signal output from the reception antenna 21 using the transmission signal output from the signal generating unit 11.

The receiver 22 outputs the time-series reception signal to the A/D converter 23.

The A/D converter 23 converts the time-series reception signal output from the receiver 22 from an analog signal to a digital signal, and outputs a reception video signal which is a digital signal to a low-order compensating unit 31 described later.

In the radar device 1 illustrated in FIG. 1, the reception unit 20 includes one reception antenna 21. However, this is merely an example, and the reception unit 20 may include a plurality of reception antennas 21, and the plurality of reception antennas 21 may constitute an array antenna.

Note that each of the transmission systems in the transmission unit 10 and the reception unit 20 may be any transmission system, and for example, a multiple input multiple output (MIMO) system can be used as each of the transmission systems.

The signal processor 30 includes the low-order compensating unit 31, a high-order phase linearizing unit 32, a high-order coherent integrating unit 33, and a target detection unit 34.

The signal processor 30 detects the target by performing signal processing on the reception video signal output from the reception unit 20.

The low-order compensating unit 31 is implemented by, for example, a low-order compensating circuit 41 illustrated in FIG. 2.

The low-order compensating unit 31 acquires time-series reception video signals from the A/D converter 23 and suppresses a phase change of the reception video signal due to a low-order component included in the time-series reception video signals.

The low-order compensating unit 31 outputs the time-series reception video signals after the phase change suppression to the high-order phase linearizing unit 32.

The high-order phase linearizing unit 32 is implemented by, for example, a high-order phase linearizing circuit 42 illustrated in FIG. 2.

The high-order phase linearizing unit 32 acquires the time-series reception video signals after the phase change suppression output from the low-order compensating unit 31.

The high-order phase linearizing unit 32 raises the sampling number of the reception video signal to power by using an order of the high-order component included in the time-series reception video signals as a power index. When the sampling number of the reception video signal is raised to the power by the high-order phase linearizing unit 32, the phase of the reception video signal that changes with the lapse of time is linearized.

The high-order phase linearizing unit 32 outputs the reception video signal after the sampling number is raised to the power to the high-order coherent integrating unit 33.

The high-order coherent integrating unit 33 is implemented by, for example, a high-order coherent integrating circuit 43 illustrated in FIG. 2.

The high-order coherent integrating unit 33 acquires the reception video signal having the sampling number raised to the power by the high-order phase linearizing unit 32.

The high-order coherent integrating unit 33 coherently integrates the acquired reception video signal and outputs the reception video signal after the coherent integration to the target detection unit 34.

The target detection unit 34 is implemented by, for example, a target detection circuit 44 illustrated in FIG. 2.

The target detection unit 34 acquires the reception video signal after the coherent integration from the high-order coherent integrating unit 33.

The target detection unit 34 detects a target to be detected on the basis of the signal intensity of the reception video signal after the coherent integration.

The target detection unit 34 outputs a target detection result to the display 2.

In FIG. 1, it is assumed that each of the low-order compensating unit 31, the high-order phase linearizing unit 32, the high-order coherent integrating unit 33, and the target detection unit 34, which are components of the signal processor 30, is implemented by dedicated hardware as illustrated in FIG. 2. That is, it is assumed that the signal processor 30 is implemented by the low-order compensating circuit 41, the high-order phase linearizing circuit 42, the high-order coherent integrating circuit 43, and the target detection circuit 44.

Each of the low-order compensating circuit 41, the high-order phase linearizing circuit 42, the high-order coherent integrating circuit 43, and the target detection circuit 44 corresponds to, for example, a single circuit, a composite circuit, a programmed processor, a parallel programmed processor, an application specific integrated circuit (ASIC), a field-programmable gate array (FPGA), or a combination thereof.

The components of the signal processor 30 are not limited to those implemented by dedicated hardware, and the signal processor 30 may be implemented by software, firmware, or a combination of software and firmware.

The software or firmware is stored in a memory of a computer as a program. The computer means hardware that executes a program, and corresponds to, for example, a central processing unit (CPU), a central processing device, a processing device, an arithmetic device, a microprocessor, a microcomputer, a processor, or a digital signal processor (DSP).

FIG. 3 is a hardware configuration diagram of a computer in a case where the signal processor 30 is implemented by software, firmware, or the like.

In a case where the signal processor 30 is implemented by software, firmware, or the like, a program for causing a computer to execute each processing procedure performed in the low-order compensating unit 31, the high-order phase linearizing unit 32, the high-order coherent integrating unit 33, and the target detection unit 34 is stored in a memory 51. Then, a processor 52 of the computer executes the program stored in the memory 51.

Furthermore, FIG. 2 illustrates an example in which each of the components of the signal processor 30 is implemented by dedicated hardware, and FIG. 3 illustrates an example in which the signal processor 30 is implemented by software, firmware, or the like. However, this is merely an example, and some components in the signal processor 30 may be implemented by dedicated hardware, and the remaining components may be implemented by software, firmware, or the like.

Next, the operation of the radar device 1 illustrated in FIG. 1 will be described.

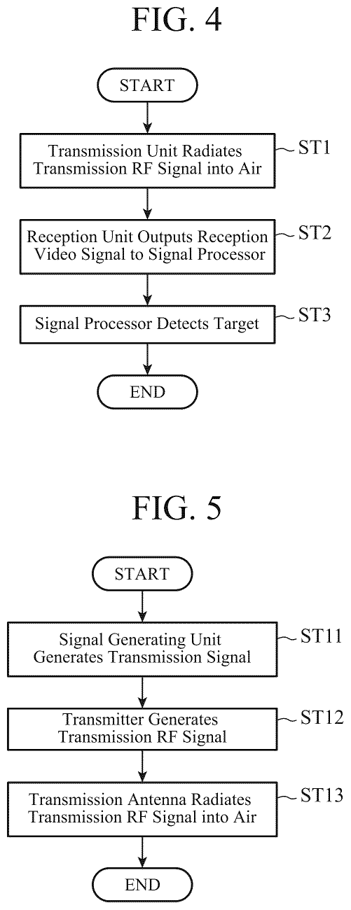

FIG. 4 is a flowchart illustrating a processing procedure performed in the radar device 1 illustrated in FIG. 1.

FIG. 5 is a flowchart illustrating a processing procedure performed in the transmission unit 10 illustrated in FIG. 1.

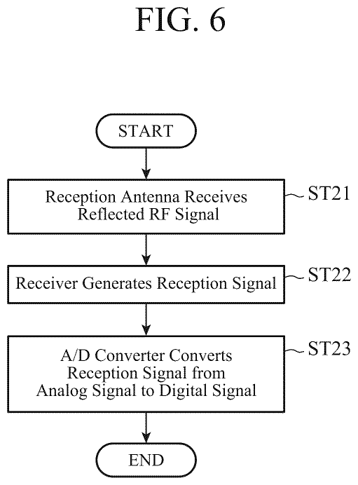

FIG. 6 is a flowchart illustrating a processing procedure performed in the reception unit 20 illustrated in FIG. 1.

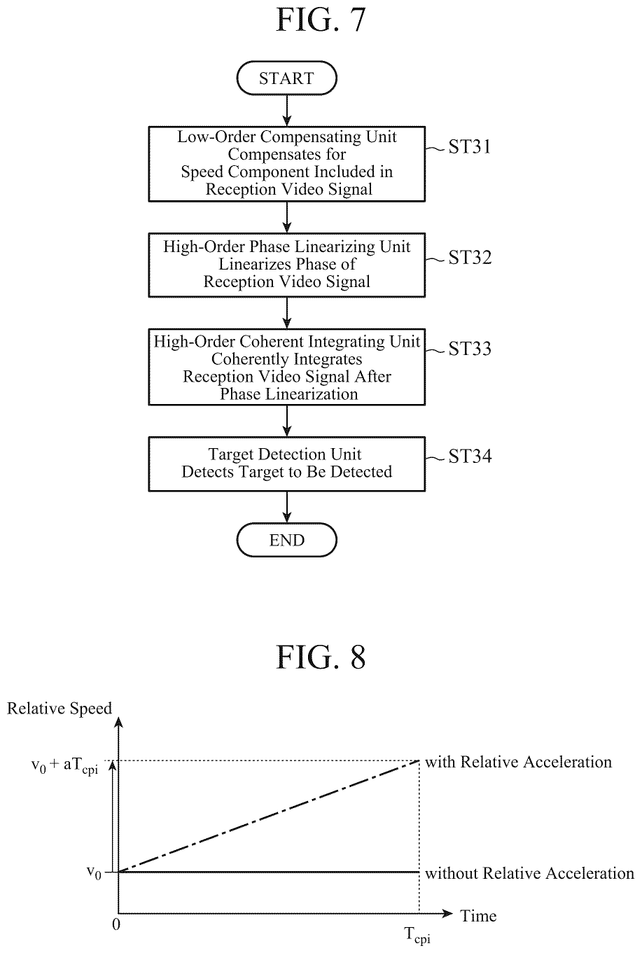

FIG. 7 is a flowchart illustrating a signal processing method which is a processing procedure performed in the signal processor 30 illustrated in FIG. 1.

First, the transmission unit 10 radiates a transmission RF signal that is an electromagnetic wave into the air (step ST1 in FIG. 4).

Hereinafter, a processing procedure performed in the transmission unit 10 will be specifically described.

The signal generating unit 11 generates a transmission signal and outputs the transmission signal to each of the transmitter 12 and the receiver 22 (step ST11 in FIG. 5).

Upon receiving the transmission signal from the signal generating unit 11, the transmitter 12 generates a transmission RF signal from the transmission signal and outputs the transmission RF signal to the transmission antenna 13 (step ST12 in FIG. 5).

The transmission antenna 13 radiates the transmission RF signal output from the transmitter 12 into the air (step ST13 in FIG. 5).

A part of the transmission RF signal radiated from the transmission antenna 13 into the air is reflected by the target to be detected.

The reception unit 20 receives the reflected wave from the target to be detected, and outputs a reception video signal V(m), which is a time-series reception signal of the reflected wave, to the signal processor 30 (step ST2 in FIG. 4). The symbol m is the sampling number.

Hereinafter, a processing procedure performed in the reception unit 20 will be specifically described.

The reception antenna 21 receives a time-series reflected RF signal of the reflected wave from the target to be detected, and outputs the time-series reflected RF signal to the receiver 22 (step ST21 in FIG. 6).

The receiver 22 acquires the time-series reflected RF signal from the reception antenna 21 and acquires a transmission signal from the signal generating unit 11.

The receiver 22 down-converts the frequency of the reflected RF signal using the transmission signal to generate a time-series reception signal (step ST22 in FIG. 6).

The receiver 22 outputs the time-series reception signal to the A/D converter 23.

The A/D converter 23 converts the time-series reception signal output from the receiver 22 from an analog signal to a digital signal (step ST23 in FIG. 6).

The A/D converter 23 outputs a reception video signal V(m), which is a digital signal, to the low-order compensating unit 31.

The signal processor 30 detects a target by performing signal processing on the reception video signal V(m) output from the reception unit 20 (step ST3 in FIG. 4).

Hereinafter, a processing procedure performed in the signal processor 30 will be specifically described.

The low-order compensating unit 31 acquires the time-series reception video signals V(m) from the A/D converter 23.

The time-series reception video signals V(m) are expressed by the following Formula (1).

$$V ( m ) = exp ( - j 2 π \frac{2 {f}_{0}}{c} ( {R}_{0} - {v}_{0} m Δ t - \frac{1}{2} {am}^{2} Δ {t}^{2} ) ) \qquad ( 1 )$$

$$( m = 0 , 1 , … , M - 1 )$$

In Formula (1), f₀ is a frequency of the transmission RF signal, and c is the speed of light.

R₀ is an initial relative distance between the radar device 1 and the target, v₀ is an initial relative speed between the radar device 1 and the target, and a is a relative acceleration between the radar device 1 and the target.

M is the number of samplings, and Δt is the sampling interval.

A first-order term of time in the reception video signal V(m) is a target speed component indicating the relative speed between the radar device 1 and the target. A quadratic term of time in the reception video signal V(m) is a target acceleration component indicating the relative acceleration between the radar device 1 and the target.

In the reception video signal V(m), in a case where the influence of the target velocity component is sufficiently large as compared with the target acceleration component, that is, in a case where the target acceleration component is close to 0, the reception video signal V(m) is approximated as the following Formula (2).

$$V ( m ) ≅ exp ( - j 2 π \frac{2 {f}_{0}}{c} ( {R}_{0} - {v}_{0} m Δ t ) ) \qquad ( 2 )$$

$$( m = 0 , 1 , … , M - 1 )$$

When the reception video signal V(m), which is sufficiently influenced by the target speed component as compared with the target acceleration component, is converted into the frequency domain signal f_{d}(m_{fft}), the frequency domain signal f_{d}(m_{fft}) is expressed by the following Formula (3).

$${f}_{d} ( {m}_{fft} ) = {\sum }_{m = 0}^{M - 1} [ V ( m ) exp ( - j 2 π \frac{{m}_{fft}}{{M}_{fft}} m ) ] = {\sum }_{m = 0}^{M - 1} [ exp ( - j 2 π \frac{2 {f}_{0}}{c} ( {R}_{0} - {v}_{0} m Δ t ) ) exp ( - j 2 π \frac{{m}_{fft}}{{M}_{fft}} m ) ] = exp ( - j 2 π \frac{2 {f}_{0}}{c} {R}_{0} ) {\sum }_{m = 0}^{M - 1} [ exp ( j 2 π ( \frac{2 {f}_{0}}{c} {v}_{0} Δ t - \frac{{m}_{fft}}{{M}_{fft}} ) m ) ] \qquad ( 3 )$$

$$( {m}_{fft} = 0 , 1 , … , {M}_{fft} - 1 )$$

In Formula (3), me represents a frequency number, and M_{fft} represents the number of frequency domain conversion points.

When the relationship expressed by the following Formula (4) is satisfied, the reception video signal V(m) is coherently integrated, and thus, is most efficiently integrated. The efficient integration of the reception video signal V(m) increases the signal-to-noise ratio and improves the target detection performance.

$$\frac{2 {f}_{0}}{c} {v}_{0} Δ t - \frac{{m}_{fft}}{{M}_{fft}} = 0 \qquad ( 4 )$$

On the other hand, in a case where the influence of the target acceleration component is large in the reception video signal V(m), that is, in a case where the target acceleration component is not 0, when the reception video signal V(m) is converted into the frequency domain signal f_{d}(m_{fft}), the frequency domain signal f_{d}(m_{fft}) is expressed as the following Formula (5).

$${f}_{d} ( {m}_{fft} ) = {\sum }_{m = 0}^{M - 1} [ {V}_{0} ( m ) exp ( - j 2 π \frac{{m}_{fft}}{{M}_{fft}} m ) ] = {\sum }_{m = 0}^{M - 1} [ exp ( - j 2 π \frac{2 {f}_{0}}{c} ( {R}_{0} - {v}_{0} m Δ t - \frac{1}{2} {am}^{2} Δ {t}^{2} ) ) exp ( - j 2 π \frac{{m}_{fft}}{{M}_{fft}} m ) ] = exp ( - j 2 π \frac{2 {f}_{0}}{c} {R}_{0} ) {\sum }_{m = 0}^{M - 1} [ exp ( j 2 π ( \frac{2 {f}_{0}}{c} {v}_{0} Δ t - \frac{{f}_{0}}{c} am Δ {t}^{2} - \frac{{m}_{fft}}{{M}_{fft}} ) m ) ] \qquad ( 5 )$$

$$( {m}_{fft} = 0 , 1 , … , {M}_{fft} - 1 )$$

In a case where the influence of the target acceleration component is large in the reception video signal V(m), the reception video signal V(m) is spread to a plurality of different speeds and integrated, and thus the integration efficiency is deteriorated. As the integration efficiency of the reception video signal V(m) deteriorates, the target detection performance deteriorates.

FIG. 8 is an explanatory diagram illustrating a relative speed in a case where the relative acceleration changes and a relative speed in a case where the relative acceleration does not change during the integration time T_{cpi} of the reception video signal V(m).

In FIG. 8, the horizontal axis represents time, and the vertical axis represents relative speed.

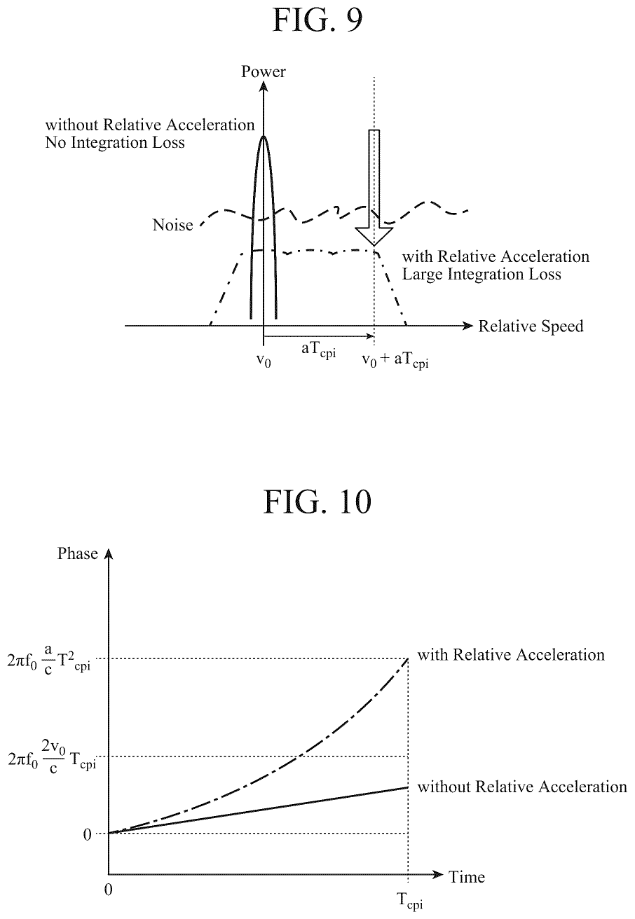

FIG. 9 is an explanatory diagram illustrating an integration loss generated when the relative acceleration changes during the integration time T_{cpi} of the reception video signal V(m).

In FIG. 9, the horizontal axis represents relative speed, and the vertical axis represents power.

In a case where the relative acceleration does not change during the integration time T_{cpi} of the reception video signal V(m), the reception video signal V(m) is coherently integrated with respect to the relative speed v₀ as illustrated in FIG. 9, so that there is almost no integration loss.

On the other hand, in a case where the relative acceleration changes during the integration time T_{cpi} of the reception video signal V(m), the reception video signal V(m) is spread and integrated with respect to the speed between the relative speed v₀ and the relative speed v₀+aT_{cpi} as illustrated in FIG. 9, and thus, the integration loss is large.

When acquiring the time-series reception video signals V(m) from the A/D converter 23, the low-order compensating unit 31 compensates for a speed component that is a low-order component included in the reception video signals V(m) to suppress a phase change of the reception video signal due to the low-order component as expressed in the following Formula (6) (step ST31 in FIG. 7).

In the frequency domain signal f_{d}(m_{fft}), as expressed in Formula (5), the order of time in the speed component (2f₀/c)×v₀Δt that is the low-order component is different from the order of time in the acceleration component (f₀/c)×amΔt² that is the high-order component. For this reason, it is difficult to simultaneously integrate both the low-order component and the high-order component. However, since the low-order compensating unit 31 compensates for the speed component that is the low-order component included in the reception video signal V(m), the high-order coherent integrating unit 33 at the subsequent stage can coherently integrate the high-order component.

$${V}_{v} ( m ) = V ( m ) exp ( - j 2 π \frac{2 {f}_{0}}{c} {v}_{0}^{′} m Δ t ) \\ ( m = 0 , 1 , … , M - 1 ) \qquad ( 6 )$$

In Formula (6), v₀′ represents a target speed acquired in advance or a target speed candidate. Vᵥ(m) is time-series reception video signals after phase change suppression due to the low-order component.

The low-order compensating unit 31 outputs the time-series reception video signals Vᵥ(m) after the phase change suppression to the high-order phase linearizing unit 32.

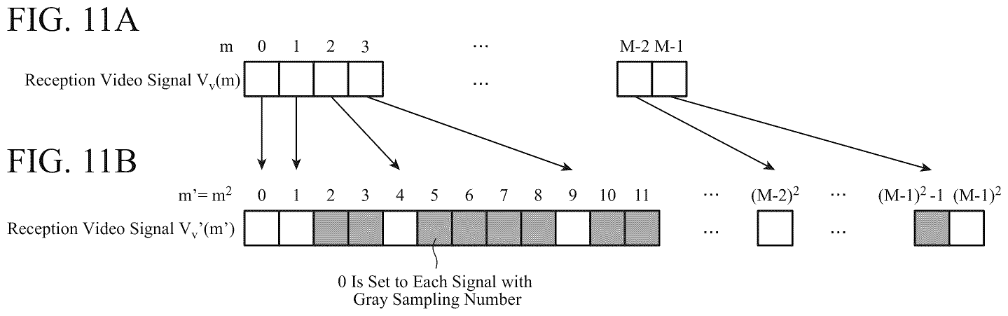

FIG. 10 is an explanatory diagram illustrating a temporal change of a phase in a case where a relative acceleration does not change and a temporal change of a phase in a case where the relative acceleration changes.

In FIG. 10, the horizontal axis represents time, and the vertical axis represents phase.

In a case where the relative acceleration does not change while the time changes from 0 to T_{cpi}, the phase of the reception video signal Vᵥ(m) linearly changes with the lapse of time (see the solid line in FIG. 10). In a case where the phase does not change linearly, the high-order coherent integrating unit 33 can coherently integrate the reception video signal Vᵥ(m) by performing fast Fourier transform on the reception video signal Vᵥ(m).

On the other hand, in a case where the relative acceleration changes while the time changes from 0 to T_{cpi}, the phase of the reception video signal Vᵥ(m) changes nonlinearly with the lapse of time (see the alternate long and short dash line in FIG. 10). In a case where the phase changes nonlinearly, the high-order coherent integrating unit 33 cannot perform fast Fourier transform on the reception video signal Vᵥ(m). If the high-order coherent integrating unit 33 cannot perform fast Fourier transform on the reception video signal Vᵥ(m), it is difficult to coherently integrate high-order components of the reception video signal Vᵥ(m) in a short time.

The high-order phase linearizing unit 32 acquires the time-series reception video signals Vᵥ(m) after the phase change suppression from the low-order compensating unit 31.

The high-order phase linearizing unit 32 linearizes the phase of the reception video signal Vᵥ(m) that changes with the lapse of time in order to enable the fast Fourier transform of the reception video signal Vᵥ(m) by the high-order coherent integrating unit 33 (step ST32 in FIG. 7).

That is, the high-order phase linearizing unit 32 linearizes the phase of the reception video signal Vᵥ(m) by raising the sampling number m of the reception video signal Vᵥ(m) to power by using an order Nₘᵤₗₜᵢ of the high-order component included in the reception video signal Vᵥ(m) as the power index as expressed in the following Formula (7). When the high-order component is, for example, a second-order acceleration component, the order Nₘᵤₗₜᵢ is “2”. When the high-order component is, for example, a third-order acceleration component, the order Nₘᵤₗₜᵢ is “3”. Further, when the high-order component is, for example, a fourth-order acceleration component, the order Nₘᵤₗₜᵢ is “4”.

$${V}_{v}^{′} ( {m}^{′} ) = \{ \begin{matrix}{V}_{v} ( m ) , {m}^{′} = {m}^{{N}_{multi}} \\ 0 , otherwise\end{matrix} \\ ( m = 0 , 1 , … , M - 1 ) \\ ( {m}^{′} = 0 , 1 , … , {M}^{′} ) \\ ( {M}^{′} = {( M - 1 )}^{{N}_{multi}} ) \qquad ( 7 )$$

In Formula (7), m′ is a sampling number of the reception video signal Vᵥ′(m′) after the phase linearization, and M′ is the number of sampling points of the reception video signal Vᵥ′(m′) after the phase linearization.

The high-order phase linearizing unit 32 outputs the reception video signal Vᵥ′(m′) after the phase linearization to the high-order coherent integrating unit 33.

FIG. 11A is an explanatory diagram illustrating the reception video signal Vᵥ(m) after phase change suppression by the low-order compensating unit 31. FIG. 11B is an explanatory diagram illustrating the reception video signal Vᵥ′(m′) after the phase linearization by the high-order phase linearizing unit 32 when Nₘᵤₗₜᵢ=2.

The sampling numbers m of the reception video signals Vᵥ(m) after the phase change suppression by the low-order compensating unit 31 are 0 to (M−1) as illustrated in FIG. 11A.

The sampling number m′ of the reception video signal Vᵥ′(m′) after the phase linearization by the high-order phase linearizing unit 32 is the value obtained by squaring the sampling number m of the reception video signal Vᵥ(m). That is, m′=m².

Therefore, the sampling number m′ of the reception video signal Vᵥ′(m′) after the phase linearization is m′=0, 1, 4, 9, . . . (M−2)², . . . , (M−1)² as illustrated in FIG. 11B. Note that the high frequency components (in the drawing, signals with gray sampling numbers) with the sampling number m′ of m′=2, 3, 5, 6, 7, 8, 10, 11, . . . , (M−1)²−1 are set to 0 by the high-order phase linearizing unit 32.

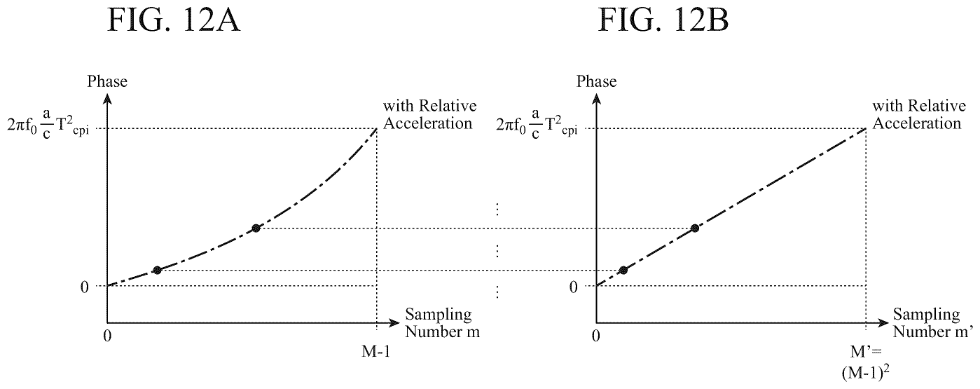

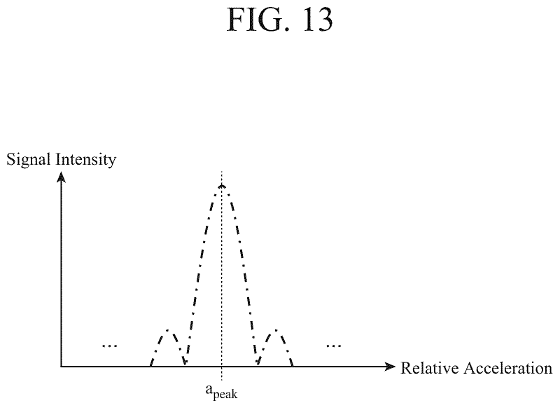

FIG. 12A is an explanatory diagram illustrating a relationship between a sampling number m and a phase of the reception video signal Vᵥ(m) after the phase change suppression by the low-order compensating unit 31. FIG. 12B is an explanatory diagram illustrating a relationship between a sampling number m′ and a phase of the reception video signal Vᵥ′(m′) after the phase linearization by the high-order phase linearizing unit 32.

In FIGS. 12A and 12B, the horizontal axis represents the sampling number, and the vertical axis represents the phase.

In a case where the relative acceleration changes, as illustrated in FIG. 12A, the phase of the reception video signal Vᵥ(m) changes nonlinearly when the sampling number m changes from 0 to (M−1). That is, the phase of the reception video signal Vᵥ(m) changes quadratically.

In a case where the relative acceleration changes, as illustrated in FIG. 12B, the phase of the reception video signal Vᵥ′(m′) changes linearly when the sampling number m′ changes from 0 to (M−1)².

The high-order coherent integrating unit 33 acquires the reception video signal Vᵥ′(m′) after the phase linearization from the high-order phase linearizing unit 32.

The high-order coherent integrating unit 33 coherently integrates the reception video signal Vᵥ′(m′) as expressed in the following Formula (9) by performing fast Fourier transform on the reception video signal Vᵥ′(m′) after the phase linearization as expressed in the following Formula (8) (step ST33 in FIG. 7).

$${f}_{v , H} ( {m}_{fft}^{′} ) = {FFT}_{H} [ {V}_{v}^{′} ( {m}^{′} ) ] \\ ( {m}_{fft}^{′} = 0 , 1 , … , {M}_{fft}^{′} - 1 ) \qquad ( 8 )$$

$${f}_{v , H} ( {m}_{fft}^{′} ) = {\sum }_{{m}^{′} = 0}^{{M}^{′} - 1} {V}_{v}^{′} ( {m}^{′} ) exp ( - j 2 π \frac{{m}_{fft}^{′}}{{M}_{fft}^{′}} {m}^{′} ) \\ ( {m}_{fft}^{′} = 0 , 1 , … , {M}_{fft}^{′} - 1 ) \qquad ( 9 )$$

In Formula (8), FFT_{H}[X] is a mathematical symbol indicating the fast Fourier transform for the variable X.

f_{v,h}(m′_{fft}) is a reception video signal after the coherent integration, m′_{fft} is the sampling number of the reception video signal f_{v,h}(m′_{fft}) after the coherent integration, and M′_{fft} is the number of sampling points of the reception video signal f_{v,h}(m′_{fft}) after the coherent integration.

The high-order coherent integrating unit 33 outputs the reception video signal f_{v,h}(m′_{fft}) after the coherent integration to the target detection unit 34.

FIG. 13 is an explanatory diagram illustrating a reception video signal f_{v,h}(m′_{fft}) after coherent integration.

In FIG. 13, the horizontal axis represents the relative acceleration, and the vertical axis represents the signal intensity (power) of the reception video signal f_{v,h}(m′_{fft}). aₚₑₐₖ is a relative acceleration when the signal intensity of the reception video signal f_{v,h}(m′_{fft}) is maximized.

When the reception video signal f_{v,h}(m′_{fft}) after the coherent integration is expressed by the following Formula (10), the integration efficiency is improved and the signal intensity is maximized as illustrated in FIG. 13.

The sampling number m′_{fft} of the reception video signal f_{v,h}(m′_{fft}) after the high-order coherent integration when the signal intensity is maximized is expressed by the following Formula (11).

$${f}_{v , H} ( {m}_{fft}^{′} ) = \qquad ( 10 )$$

$$exp ( - j 2 π \frac{2 {f}_{0}}{c} {R}_{0} ) {\sum }_{{k}_{v} = 0}^{{K}_{v} - 1} exp ( j 2 π ( \frac{{f}_{0}}{c} a Δ {t}^{′} - \frac{{m}_{fft}^{′}}{{M}_{fft}^{′}} ) {m}^{′} ) ∴ \frac{{f}_{0}}{c} a Δ {t}^{′} - \frac{{m}_{fft}^{′}}{{M}_{fft}^{′}} = 0$$

$${m}_{fft , peak}^{′} = \frac{{f}_{0}}{c} {a}_{peak} Δ {t}^{′} {M}_{fft}^{′} \qquad ( 11 )$$

In the signal processor 30 illustrated in FIG. 1, the high-order coherent integrating unit 33 coherently integrates the reception video signal Vᵥ′(m′) by performing the fast Fourier transform on the reception video signal Vᵥ′(m′) after the phase linearization. However, this is merely an example, and the high-order coherent integrating unit 33 may coherently integrate the reception video signal Vᵥ′(m′) by performing the chirp Z-transform on the reception video signal Vᵥ′(m′) after the phase linearization as expressed in the following Formula (12).

$${f}_{v , H} ( {m}_{czt}^{′} ) = {CZT}_{H} [ {V}_{v}^{′} ( {m}^{′} ) ] = {\sum }_{{m}^{′} = 0}^{{M}^{′} - 1} {V}_{v}^{′} ( {m}^{′} ) {z}_{- {m}_{czt}^{′}}^{- {m}^{′}} = {\sum }_{{m}^{′} = 0}^{{M}^{′} - 1} {V}_{v}^{′} ( {m}^{′} ) {( {A}_{H} {W}_{H}^{- {m}_{czt}^{′}} )}^{- {m}^{′}} = exp ( - j 2 π \frac{2 {f}_{0}}{c} {R}_{0} ) {\sum }_{{m}^{′} = 0}^{{M}^{′} - 1} exp ( j 2 π \frac{{f}_{0}}{c} ( a - {a}_{st} - Δ {a}_{czt} {m}_{czt}^{′} ) {m}^{′} Δ {t}^{′} ) \\ ( {m}_{czt}^{′} = 0 , 1 , … , {M}_{czt}^{′} - 1 ) \qquad ( 12 )$$

In Formula (12), CZT_{H}[X] is a mathematical symbol indicating the chirp Z-transform for the variable X, z_{-m′czt}^{-m′} is a transform coefficient of the chirp Z-transform, aₛₜ is a transform start acceleration, and Δa_{czt} is a transform acceleration interval.

A_{H} is a phase corresponding to the transform start acceleration of the chirp Z-transform expressed by the following Formula (13).

W_{H} is a phase corresponding to the transform acceleration interval of the chirp Z-transform expressed by the following Formula (14).

m′_{czt} is a sampling number of the reception video signal f_{v,h}(m′_{fft}) after the chirp Z-transform, and M′_{czt} is the number of sampling points of the reception video signal f_{v,h}(m′_{fft}) after the chirp Z-transform.

$${A}_{H} = exp ( - j 2 π {f}_{0} \frac{{a}_{st}}{c} Δ {t}^{′} ) \qquad ( 13 )$$

$${W}_{H} = exp ( - j 2 π {f}_{0} \frac{Δ {a}_{czt}}{c} Δ {t}^{′} ) \qquad ( 14 )$$

$$a - {a}_{st} - Δ {a}_{czt} {m}_{czt}^{′} = 0 \qquad ( 15 )$$

$${a}_{peak} = {a}_{st} + Δ {a}_{czt} {m}_{czt , peak}^{′} \qquad ( 16 )$$

The chirp Z-transform expressed by Formula (12) can be performed by processing using fast Fourier transform, and can be performed at high speed. The high-order coherent integrating unit 33 can coherently integrate the reception video signal Vᵥ′(m′) in any acceleration range and at any acceleration interval by using the chirp Z-transform.

The target detection unit 34 acquires the reception video signal f_{v,h}(m′_{fft}) after the coherent integration from the high-order coherent integrating unit 33.

The target detection unit 34 detects a target to be detected on the basis of the signal intensity of the reception video signals f_{v,h}(m′_{fft}) after the coherent integration (step ST34 in FIG. 7).

The target detection unit 34 detects the target to be detected, for example, by performing CFAR (Constant False Alarm Rate) processing on the signal intensity of the reception video signal f_{v,h}(m′_{fft}) after the coherent integration.

In addition, the target detection unit 34 specifies each of the speed and the acceleration by specifying each of the sampling number in the speed direction and the sampling number in the acceleration direction corresponding to the detected target.

The target detection unit 34 outputs each of the speed and the acceleration at the target to be detected to the display 2.

In the first embodiment described above, the signal processor 30 is configured to include the high-order phase linearizing unit 32 that acquires the input reception signal of the reflected wave from the target to be detected and raises the sampling number of the input reception signal to power by using an order of the high-order component included in the input reception signal as the power index, and the high-order coherent integrating unit 33 that performs coherent integration of the reception signal having the sampling number raised to the power by the high-order phase linearizing unit 32. Therefore, the signal processor 30 can suppress the occurrence of the integration loss associated with the coherent integration without assuming the target acceleration.

### Second Embodiment

In a second embodiment, a signal processor 30 including a low-order frequency domain converting unit 35 to acquire a reception signal of a reflected wave from a target to be detected, extract a plurality of partialized reception signals that are a set of some reception signals having sampling numbers different from each other from the reception signal, and convert each of the partialized reception signals into a frequency domain signal will be described.

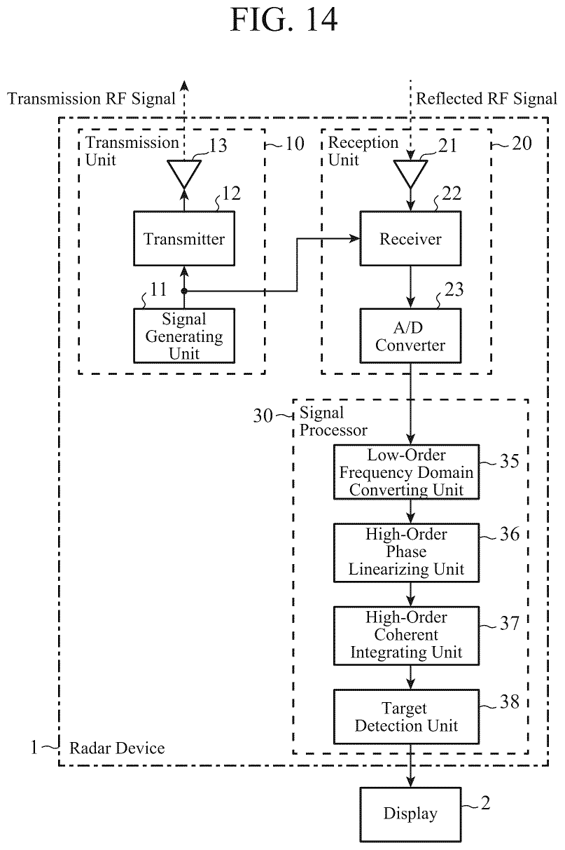

FIG. 14 is a configuration diagram illustrating a radar device 1 including the signal processor 30 according to the second embodiment.

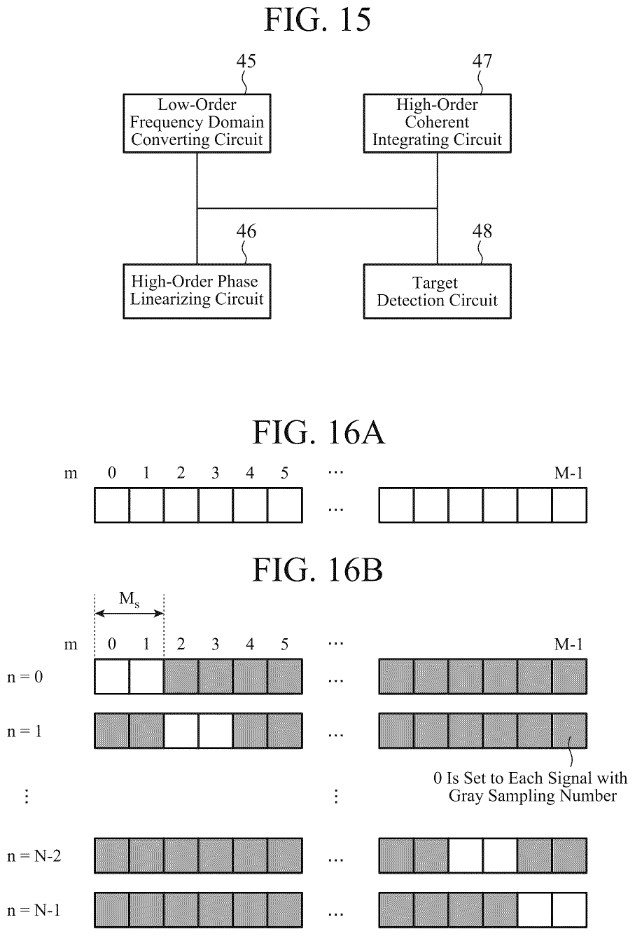

FIG. 15 is a hardware configuration diagram illustrating hardware of the signal processor 30 according to the second embodiment.

In FIGS. 14 and 15, the same reference numerals as those in FIGS. 1 and 2 denote the same or corresponding parts, and thus description thereof is omitted.

The signal processor 30 includes a low-order frequency domain converting unit 35, a high-order phase linearizing unit 36, a high-order coherent integrating unit 37, and a target detection unit 38.

The signal processor 30 detects the target by performing signal processing on the reception video signal V(m) output from the reception unit 20.

The low-order frequency domain converting unit 35 is implemented by, for example, a low-order frequency domain converting circuit 45 illustrated in FIG. 15.

The low-order frequency domain converting unit 35 acquires time-series reception video signals V(m) from the A/D converter 23, and extracts a plurality of partialized reception video signals Vₛ(n,m) which are a set of some reception signals having different sampling numbers from each other from the time-series reception video signals V(m). n is a variable (hereinafter, referred to as a “partializing number”) for identifying the partialized reception video signals Vₛ(n,m) having different sampling numbers.

The low-order frequency domain converting unit 35 converts each of the partialized reception video signals Vₛ(n,m) into a frequency domain signal f_{L}(n,m_{fft}). By converting each of the partialized reception video signals Vₛ(n,m) into a frequency domain signal f_{L}(n,m_{fft}) by the low-order frequency domain converting unit 35, a phase change of the partialized reception video signal Vₛ(n,m) due to a low-order component included in the partialized reception video signal Vₛ(n,m) is suppressed.

The low-order frequency domain converting unit 35 outputs the frequency domain signal f_{L}(n,m_{fft}) to the high-order phase linearizing unit 36.

The high-order phase linearizing unit 36 is implemented by, for example, a high-order phase linearizing circuit 46 illustrated in FIG. 15.

The high-order phase linearizing unit 36 acquires the frequency domain signal f_{L}(n,m_{fft}) output from the low-order frequency domain converting unit 35.

The high-order phase linearizing unit 36 raises a partializing number n that is a sampling number of the frequency domain signal f_{L}(n,m_{fft}) to power by using the order of the high-order component included in the frequency domain signal f_{L}(n,m_{fft}) as a power index. The phase of the frequency domain signal f_{L}(n,m_{fft}) having the partializing number n raised to the power by the high-order phase linearizing unit 36 is linearized.

The high-order phase linearizing unit 36 outputs a signal f_{L}′(n′,m_{fft}) after phase linearization, which is the frequency domain signal after the partializing number n is raised to the power, to the high-order coherent integrating unit 37.

The high-order coherent integrating unit 37 is implemented by, for example, a high-order coherent integrating circuit 47 illustrated in FIG. 15.

The high-order coherent integrating unit 37 acquires the signal f_{L}′(n′,m_{fft}) after phase linearization from the high-order phase linearizing unit 36.

The high-order coherent integrating unit 37 coherently integrates the signal f_{L}′(n′,m_{fft}) after phase linearization, and outputs the signal f_{L,H}(k_{fft},m_{fft}) after the coherent integration to the target detection unit 38.

The target detection unit 38 is implemented by, for example, a target detection circuit 48 illustrated in FIG. 15.

The target detection unit 38 acquires the signal f_{L,H}(k_{fft},m_{fft}) after the coherent integration from the high-order coherent integrating unit 37.

The target detection unit 38 detects the target to be detected on the basis of the signal intensity of the signal f_{L,H}(k_{fft},m_{fft}) after the coherent integration.

The target detection unit 38 outputs a target detection result to the display 2.

In FIG. 14, it is assumed that each of the low-order frequency domain converting unit 35, the high-order phase linearizing unit 36, the high-order coherent integrating unit 37, and the target detection unit 38, which are components of the signal processor 30, is implemented by dedicated hardware as illustrated in FIG. 15. That is, it is assumed that the signal processor 30 is implemented by the low-order frequency domain converting circuit 45, the high-order phase linearizing circuit 46, the high-order coherent integrating circuit 47, and the target detection circuit 48.

Each of the low-order frequency domain converting circuit 45, the high-order phase linearizing circuit 46, the high-order coherent integrating circuit 47, and the target detection circuit 48 corresponds to, for example, a single circuit, a composite circuit, a programmed processor, a parallel-programmed processor, ASIC, FPGA, or a combination thereof.

The components of the signal processor 30 are not limited to those implemented by dedicated hardware, and the signal processor 30 may be implemented by software, firmware, or a combination of software and firmware.

In a case where the signal processor 30 is implemented by software, firmware, or the like, a program for causing a computer to execute each processing procedure in the low-order frequency domain converting unit 35, the high-order phase linearizing unit 36, the high-order coherent integrating unit 37, and the target detection unit 38 is stored in the memory 51 illustrated in FIG. 3. Then, the processor 52 illustrated in FIG. 3 executes the program stored in the memory 51.

Furthermore, FIG. 15 illustrates an example in which each of the components of the signal processor 30 is implemented by dedicated hardware, and FIG. 3 illustrates an example in which the signal processor 30 is implemented by software, firmware, or the like. However, this is merely an example, and some components in the signal processor 30 may be implemented by dedicated hardware, and the remaining components may be implemented by software, firmware, or the like.

Next, the operation of the radar device 1 illustrated in FIG. 14 will be described. However, since the radar device 1 is similar to the radar device 1 illustrated in FIG. 1 except for the low-order frequency domain converting unit 35, the high-order phase linearizing unit 36, the high-order coherent integrating unit 37, and the target detection unit 38, only the operations of the low-order frequency domain converting unit 35, the high-order phase linearizing unit 36, the high-order coherent integrating unit 37, and the target detection unit 38 will be described here.

The low-order frequency domain converting unit 35 acquires the time-series reception video signals V(m) from the A/D converter 23.

The low-order frequency domain converting unit 35 extracts a plurality of partialized reception video signals Vₛ(n,m) having sampling numbers different from each other from the reception video signals V(m) as expressed in the following Formula (17).

$${V}_{s} ( n , m ) = \{ \begin{matrix}V ( m ) , {nM}_{s} \leq m < {nM}_{s} + {M}_{s} - 1 \\ 0 , otherwise\end{matrix} \\ ( n = 0 , 1 , … , N - 1 ) \\ ( m = 0 , 1 , … , M - 1 ) \qquad ( 17 )$$

$$N = \frac{M}{{M}_{s}} \qquad ( 18 )$$

In Formula (17), N is the number of partialization expressed by Formula (18), and Mₛ is the number of the partialized reception video signals.

FIG. 16A is an explanatory diagram illustrating the reception video signal V (m) output from the A/D converter 23. FIG. 16B is an explanatory diagram illustrating N partialized reception video signals Vₛ(n,m) extracted by the low-order frequency domain converting unit 35.

In the example of FIG. 16B, the partialized reception video signal Vₛ(n,m) with n=0 is the reception video signals V(m) with in =0 and 1, and the partialized reception video signal Vₛ(n,m) with n=1 is the reception video signals V(m) with m=2 and 3. Further, the partialized reception video signal Vₛ(n,m) with n=N−1 is the reception video signals V(m) with m=M−2 and M−1.

In the radar device 1 illustrated in FIG. 14, the low-order frequency domain converting unit 35 divides the reception video signals V(m) according to Formula (17). However, this is merely an example, and the low-order frequency domain converting unit 35 may extract a plurality of partialized reception video signals Vₛ(n,m) so that the partialized reception video signals Vₛ(n,m) having the partializing numbers n adjacent to each other partially overlap each other among the plurality of partialized reception video signals Vₛ(n,m).

The low-order frequency domain converting unit 35 coverts each of the partialized reception video signals Vₛ(n,m) into a frequency domain signal f_{L}(n,m_{fft}) as expressed in the following Formula (20) by performing fast Fourier transform on each of the partialized reception video signals V(n,m) as expressed in the following Formula (19). In Formula (19), FFT_{L}[X] is a mathematical symbol representing the fast Fourier transform for the variable X. The conversion into the frequency domain signal f_{L}(n,m_{fft}) by the fast Fourier transform can be performed with a small amount of calculation, and the calculation processing time is shortened.

The low-order frequency domain converting unit 35 outputs the frequency domain signal f_{L}(n,m_{fft}) to the high-order phase linearizing unit 36.

$${f}_{L} ( n , {m}_{fft} ) = {FFT}_{L} [ {V}_{s} ( n , m ) ] \\ ( n = 0 , 1 , … , N - 1 ) \\ ( {m}_{fft} = 0 , 1 , … , {M}_{fft} - 1 ) \qquad ( 19 )$$

$${f}_{L} ( n , {m}_{fft} ) = {\sum }_{m = 0}^{M - 1} [ {V}_{s} ( n , m ) exp ( - j 2 π \frac{{m}_{fft}}{{M}_{fft}} m ) ] \\ ( n = 0 , 1 , … , N - 1 ) \\ ( {m}_{fft} = 0 , 1 , … , {M}_{fft} - 1 ) \qquad ( 20 )$$

As shown in Formula (20), the low-order frequency domain converting unit 35 coverts the partialized reception video signal Vₛ(n,m) having the partializing number n=0 indicating the reference time into a frequency domain signal f_{L}(n,m_{fft}). Therefore, unlike the low-order compensating unit 31, the low-order frequency domain converting unit 35 can suppress the phase change due to the speed component that is the low-order component without acquiring the target speed or the target speed candidate in advance. That is, the low-order frequency domain converting unit 35 can generate a signal of only a phase change due to an acceleration component that is a high-order component without acquiring a target speed or a target speed candidate in advance.

In the radar device 1 illustrated in FIG. 14, the low-order frequency domain converting unit 35 coverts each of the partialized reception video signal Vₛ(n,m) into a frequency domain signal f_{L}(n,m_{fft}) by performing fast Fourier transform on each of the partialized reception video signals Vₛ(n,m). However, this is merely an example, and the low-order frequency domain converting unit 35 may convert each of the partialized reception video signals Vₛ(n,m) into a frequency domain signal f_{L}(n,m_{fft}) by performing the chirp Z-transform on each of the partialized reception video signals Vₛ(n,m) as expressed in the following Formula (21).

$${f}_{L} ( n , {m}_{fft} ) = {CZT}_{L} [ {V}_{s} ( n , m ) ] \\ ( n = 0 , 1 , … , N - 1 ) \\ ( {m}_{fft} = 0 , 1 , … , {M}_{fft} - 1 ) \qquad ( 21 )$$

In Formula (21), CZT_{L}[X] is a mathematical symbol representing the chirp Z-transform for the variable X. The low-order frequency domain converting unit 35 can convert the signal into the frequency domain signal f_{L}(n,m_{fft}) in any acceleration range and any acceleration interval by using the chirp Z-transform.

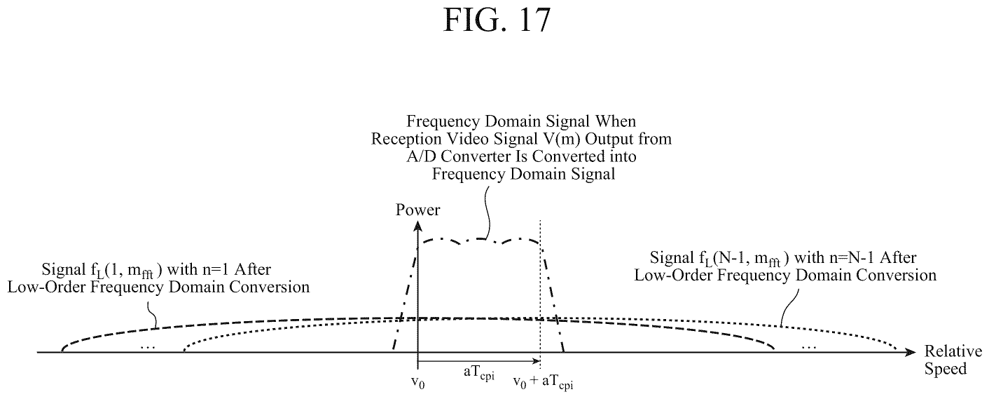

FIG. 17 is an explanatory diagram illustrating a frequency domain signal f_{L}(n,m_{fft}) and a frequency domain signal in a case where the reception video signal V(m) output from the A/D converter 23 is converted into a frequency domain signal.

In FIG. 17, the horizontal axis represents the relative speed, and the vertical axis represents the power of the frequency domain signal.

In a case where each of the partialized reception video signals Vₛ(n,m) is converted into a frequency domain signal f_{L}(n,m_{fft}), the frequency domain signal f_{L}(n,m_{fft}) is spread and integrated in the speed direction due to the influence of the acceleration component as illustrated in FIG. 17, so that a signal to noise ratio (SNR) is deteriorated.

However, the main lobes of the respective frequency domain signals f_{L}(n,m_{fft}) having the partializing number n become close as illustrated in FIG. 17. Therefore, it is possible to avoid deterioration in signal intensity and phase of the plurality of frequency domain signals f_{L}(n,m_{fft}), and integration efficiency of the same speed bin is improved.

The high-order phase linearizing unit 36 acquires the frequency domain signal f_{L}(n,m_{fft}) from the low-order frequency domain converting unit 35.

The high-order phase linearizing unit 36 linearizes the phase of the frequency domain signal f_{L}(n,m_{fft}) by raising the partializing number n of the frequency domain signal f_{L}(n,m_{fft}) to power by using the order Nₘᵤₗₜᵢ of the high-order component included in the frequency domain signal f_{L}(n,m_{fft}) as a power index as expressed in the following Formula (22).

$${f}_{L}^{′} ( {n}^{′} , {m}_{fft} ) = \{ \begin{matrix}{f}_{L} ( n , {m}_{fft} ) , {n}^{′} = {n}^{{N}_{multi}} \\ 0 , otherwise\end{matrix} \\ ( n = 0 , 1 , … , N - 1 ) \\ ( {n}^{′} = 0 , 1 , … , {N}^{′} ) \\ ( {N}^{′} = {( N - 1 )}^{{N}_{multi}} ) \\ ( {m}_{fft} = 0 , 1 , … , {M}_{fft} - 1 ) \qquad ( 22 )$$

In Formula (22), n′ is a partializing number after raised to the power, and f_{L}′(n′,m_{fft}) is a signal after phase linearization.

The high-order phase linearizing unit 36 outputs the signal f_{L}′(n,m_{fft}) after phase linearization to the high-order coherent integrating unit 37.

The high-order coherent integrating unit 37 acquires the signal f_{L}′(n′,m_{fft}) after phase linearization by the high-order phase linearizing unit 36.

The high-order coherent integrating unit 37 coherently integrates the signal f_{L}′(n′,m_{fft}) after phase linearization as expressed in the following Formula (24) by performing the fast Fourier transform on the signal f_{L}′(n′,m_{fft}) after phase linearization as expressed in the following Formula (23). In Formula (23). FFT_{H}[X] is a mathematical symbol representing the fast Fourier transform for the variable X. The conversion into the signal f_{L,H}(k_{fft}, m_{fft}) after the coherent integration by the fast Fourier transform can be performed with a small amount of calculation, and the calculation processing time is shortened.

$${f}_{L , M} ( {k}_{fft} , {m}_{fft} ) = {FFT}_{H} [ {f}_{L}^{′} ( {n}^{′} , {m}_{fft} ) ] \\ ( {m}_{fft} = 0 , 1 , … , {M}_{fft} - 1 ) \\ ( {k}_{fft} = 0 , 1 , … , {K}_{fft} - 1 ) \qquad ( 23 )$$

$${f}_{L , H} ( {k}_{fft} , {m}_{fft} ) = {\sum }_{{n}^{′} = 0}^{{N}^{′} - 1} {f}_{L}^{′} ( {n}^{′} , {m}_{fft} ) exp ( - j 2 π \frac{{k}_{fft}}{{K}_{fft}} {n}^{′} ) \\ ( {m}_{fft} = 0 , 1 , … , {M}_{fft} - 1 ) \\ ( {k}_{fft} = 0 , 1 , … , {K}_{fft} - 1 ) \qquad ( 24 )$$

In Formula (24), km represents the sampling number of the signal f_{L,H}(k_{fft}, m_{fft}) after the coherent integration, and K_{fft} represents the number of sampling points of the signal f_{L,H}(k_{fft}, m_{fft}) after the coherent integration.

The high-order coherent integrating unit 37 outputs the signal f_{L,H}(k_{fft}, m_{fft}) after the coherent integration to the target detection unit 38.

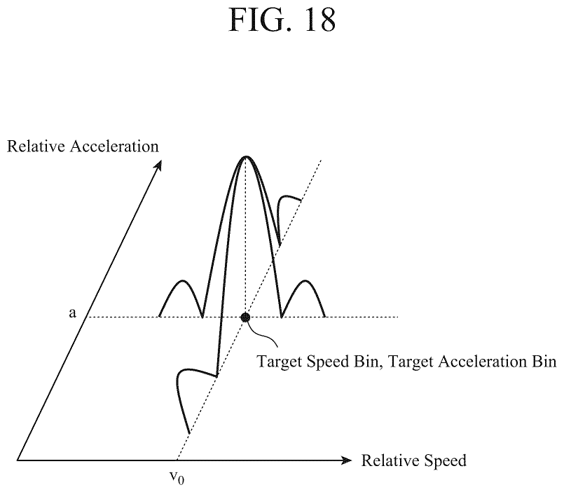

FIG. 18 is an explanatory diagram illustrating the signal f_{L,H}(k_{fft}, m_{fft}) after the coherent integration by the high-order coherent integrating unit 37.

In the example of FIG. 18, a target is present in the bin of the speed v₀ and the bin of the acceleration a.

In the radar device 1 illustrated in FIG. 14, the high-order coherent integrating unit 37 coherently integrates the signal f_{L}′(n′,m_{fft}) after the phase linearization by performing fast Fourier transform on the signal f_{L}′(n′,m_{fft}) after the phase linearization. However, this is merely an example, and the high-order coherent integrating unit 37 may coherently integrate the signal f_{L}′(n′,m_{fft}) after the phase linearization by performing the chirp Z-transform on the signal f_{L}′(n′,m_{fft}) after the phase linearization as expressed in the following Formula (25).

$${f}_{L , M} ( {k}_{fft} , {m}_{fft} ) = {CZT}_{H} [ {f}_{L}^{′} ( {n}^{′} , {m}_{fft} ) ] \\ ( {m}_{fft} = 0 , 1 , … , {M}_{fft} - 1 ) \\ ( {k}_{fft} = 0 , 1 , … , {K}_{fft} - 1 ) \qquad ( 25 )$$

In Formula (25), CZT_{H}[X] is a mathematical symbol representing the chirp Z-transform for the variable X. The high-order coherent integrating unit 37 can coherently integrate the signal f_{L}′(n′,m_{fft}) after the phase linearization in any acceleration range and at any acceleration interval by using the chirp Z-transform.

The target detection unit 38 acquires the signal f_{L,H}(k_{fft}, m_{fft}) after the coherent integration from the high-order coherent integrating unit 37.

The target detection unit 38 detects the target to be detected on the basis of the signal intensity of the signal f_{L,H}(k_{fft},m_{fft}) after the coherent integration.

The target detection unit 38 detects the target to be detected, for example, by performing CFAR processing on the signal intensity of the signal f_{L,H}(k_{fft},m_{fft}) after the coherent integration.

In addition, the target detection unit 38 specifies each of the speed and the acceleration by specifying each of the sampling number in the speed direction and the sampling number in the acceleration direction corresponding to the detected target.

The target detection unit 38 outputs each of the speed and the acceleration at the target to be detected to the display 2.

Hereinafter, target detection processing by the target detection unit 38 will be specifically described.

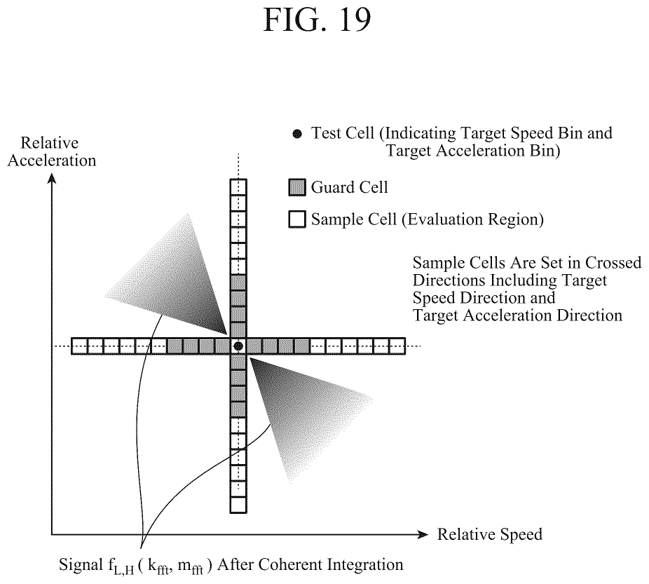

As illustrated in FIG. 19, the signal f_{L,H}(k_{fft}, m_{fft}) after the coherent integration is spread to regions other than the cross-directional region including the speed direction which is the low-order direction of the target and the acceleration direction which is the high-order direction of the target with the target to be detected as the center.

FIG. 19 is an explanatory diagram illustrating the CFAR processing on the signal f_{L,H}(k_{fft}, m_{fft}) after the coherent integration.

In FIG. 19, the horizontal axis represents relative speed, and the vertical axis represents relative acceleration.
is a test cell, gray □ indicates a guard cell, and white □ indicates a sample cell which is an evaluation region. The sample cells are set in crossed directions including a target speed direction and a target acceleration direction in order to avoid deterioration of CFAR detection performance.

The target detection unit 38 performs target detection processing by performing CFAR processing expressed by the following Formula (26).

$${P}_{cfar} ( {k}_{fft} , {m}_{fft} ) = \{ \begin{matrix}1 , Power ( {f}_{L , H} ( {k}_{fft} , {m}_{fft} ) ) > {K}_{cfar} {Power}_{sample} \\ 0 , otherwise\end{matrix} \\ ( {m}_{fft} = 0 , 1 , … , {M}_{fft} - 1 ) \\ ( {k}_{fft} = 0 , 1 , … , {K}_{fft} - 1 ) \qquad ( 26 )$$

In Formula (26), Power (X) is the power of the variable X, K_{cfar} is a coefficient set on the basis of the false alarm probability, and Powerₛₐₘₚₗₑ is the average power of the signal of the sample cell.

In the second embodiment described above, the signal processor 30 illustrated in FIG. 14 is configured to include the low-order frequency domain converting unit 35 that acquires the reception signal of the reflected wave from the target to be detected, extracts a plurality of partialized reception signals that are a set of some reception signals having sampling numbers different from each other from the reception signals, and perform conversion of the plurality of the partialized reception signals into a plurality of frequency domain signals, respectively, in which the low-order frequency domain converting unit 35 outputs each of the plurality of frequency domain signals to the high-order phase linearizing unit 36 as the input reception signal of the reflected wave. Therefore, similarly to the signal processor 30 illustrated in FIG. 1, the signal processor 30 illustrated in FIG. 14 can suppress the occurrence of the integration loss associated with the coherent integration without assuming the target acceleration. In addition, the signal processor 30 illustrated in FIG. 14 can coherently integrate high-order components included in the reception signal even in a case where the target speed or the target speed candidate cannot be obtained in advance.

In the signal processor 30 illustrated in FIG. 14, the number of partialized reception video signals when the low-order frequency domain converting unit 35 extracts the plurality of partialized reception video signals Vₛ(n,m) from the reception video signals V(m) is set to Mₛ. The number of partialized reception video signals Mₛ may be set as follows.

In a case where the target maximum acceleration aₘₐₓ is assumed, the low-order frequency domain converting unit 35 sets the number Mₛ of the reception video signals after partialization as expressed in the following Formula (27).

$${v}_{s , resol} = \frac{c}{2 {f}_{0} {M}_{s} Δ t} > {N}_{s} {a}_{max} {T}_{cpi} \qquad ( 27 )$$

In Formula (27), V_{s,resol} represents the speed resolution of the frequency domain signal f_{L}(n,m_{fft}) when the number of partialized reception video signals is Mₛ, and Nₛ represents a coefficient of the speed change amount satisfying a predetermined integration efficiency.

The low-order frequency domain converting unit 35 may compensate for the acceleration component for the reception video signal V(m) using a provisionally set acceleration a′ as expressed in the following Formula (28). In this case, the low-order frequency domain converting unit 35 extracts the plurality of partialized reception video signals Vₛ(n,m) from the reception video signals V(m) after the acceleration component compensation. The number of partialized reception video signals Mₛ when the plurality of partialized reception video signals Vₛ(n,m) are extracted from the reception video signals V(m) after the acceleration component compensation is set as Mₛ′ by the following Formula (29).

$$V ( m ) = V ( m ) exp ( - j 2 π \frac{{f}_{0}}{c} {a}^{′} {m}^{2} Δ {t}^{2} ) \\ ( m = 0 , 1 , … , M - 1 ) \qquad ( 28 )$$

$${v}_{s , resol}^{′} = \frac{c}{2 {f}_{0} {M}_{s}^{′} Δ t} > {N}_{s} ( {a}_{max} - {a}^{′} ) {T}_{cpi} \qquad ( 29 )$$

When the number of partialized reception video signals Mₛ′ is set by the Formula (29), the number of partialized reception video signals Mₛ′ can be larger than the number of partialized reception video signals Mₛ, and the partialization number N becomes smaller. As a result, the amount of calculation of the coherent integration is reduced.

In the first and second embodiments, the high-order component included in the reception video signal V(m) is a secondary component of time, that is, the high-order component is an acceleration component, and the signal processor 30 coherently integrates the acceleration component.

The signal processor 30 may coherently integrate the high-order components equal to or more than a tertiary component of time among high-order components included in the reception video signal V(m).

Hereinafter, a processing procedure when coherently integrating high-order components equal to or more than the tertiary component of time will be described.

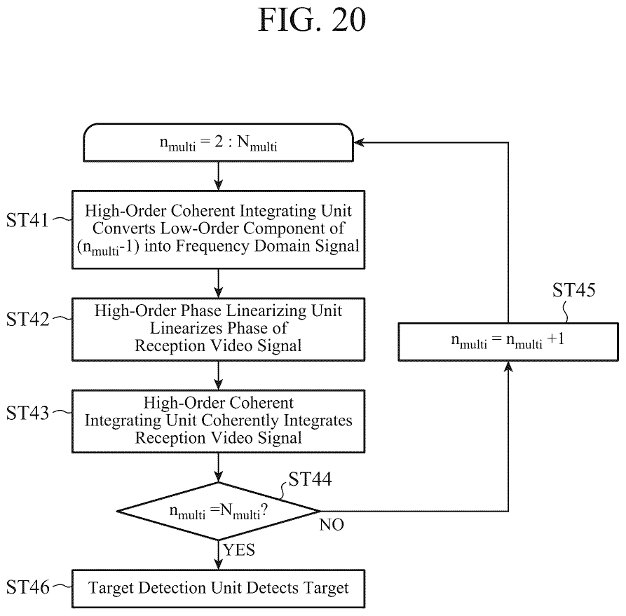

FIG. 20 is a flowchart illustrating a processing procedure when coherently integrating high-order components equal to or more than a tertiary component of time.

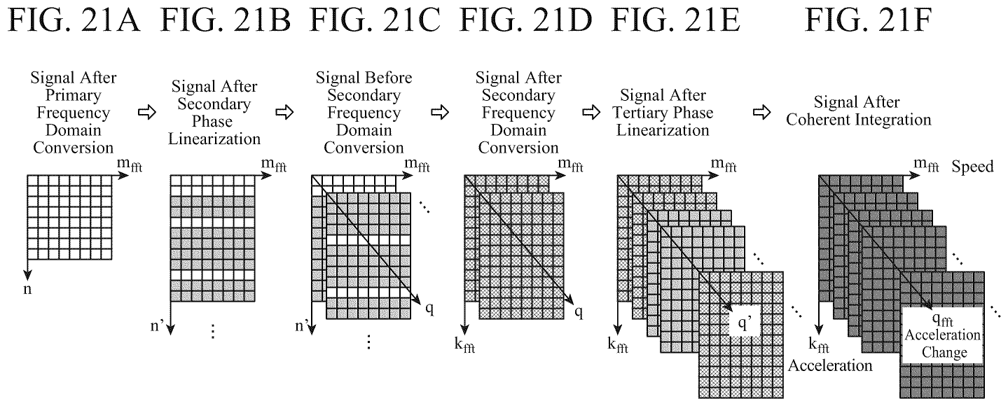

FIG. 21 is an explanatory diagram illustrating a relationship between a process of coherently integrating a tertiary component of time and a signal.

FIG. 21A illustrates a signal after primary frequency domain conversion, and FIG. 21B illustrates a signal after secondary phase linearization.

FIG. 21C illustrates a signal before secondary frequency domain conversion, and FIG. 21D illustrates a signal after the secondary frequency domain conversion.

FIG. 21E illustrates a signal after tertiary phase linearization, and FIG. 21F illustrates a signal after coherent integration.

In the signal processor 30 illustrated in FIG. 1, in the case of coherently integrating high-order components equal to or more than a tertiary component, the high-order coherent integrating unit 33 initializes a variable nₘᵤₗₜᵢ indicating the order of a high-order component to 2 and sets Nₘᵤₗₜᵢ indicating the order of a high-order component to 3 or more.

As illustrated in FIG. 21A, the high-order coherent integrating unit 33 converts a low-order component having a time order of nₘᵤₗₜᵢ−1 among high-order components included in the reception video signal Vᵥ(m) into a frequency domain signal (step ST41 in FIG. 20).

The high-order phase linearizing unit 32 linearizes the phase of the high-order component included in the reception video signal Vᵥ(m) by raising the sampling number m of the reception video signal Vᵥ(m) to power by using the order nₘᵤₗₜᵢ of the high-order component included in the reception video signal Vᵥ(m) as the power index (step ST42 in FIG. 20). The high-order phase linearizing unit 32 linearizes the phase of the high-order component by using nₘᵤₗₜᵢ instead of Nₘᵤₗₜᵢ in Formula (7).

The high-order coherent integrating unit 33 coherently integrates the reception video signal Vᵥ′(m′), which is the signal after the second-order phase linearization illustrated in FIG. 21B, as expressed in the Formula (9) (step ST43 in FIG. 20).

If the variable nₘᵤₗₜᵢ does not match Nₘᵤₗₜᵢ (step ST44 in FIG. 20: NO), the high-order coherent integrating unit 33 increments the variable nₘᵤₗₜᵢ by 1 (step ST45 in FIG. 20).

When the high-order coherent integrating unit 33 increments the variable nₘᵤₗₜᵢ by 1, the processing of steps ST41 to ST44 is repeated.

If the variable nₘᵤₗₜᵢ matches Nₘᵤₗₜᵢ (step ST44 in FIG. 20: YES), the high-order coherent integrating unit 33 ends the coherent integration processing.

In the example of FIG. 21, finally, tertiary high-order components included in the reception video signal Vᵥ(m) are coherently integrated.

Note that, in the present disclosure, it is possible to freely combine each embodiment, to modify any components of each embodiment, or to omit any components in each embodiment.

### INDUSTRIAL APPLICABILITY

The present disclosure is suitable for a signal processor, a signal processing method, and a radar device.

### REFERENCE SIGNS LIST

1: radar device, 2: display, 10: transmission unit, 11: signal generating unit, 12: transmitter, 13: transmission antenna, 20: reception unit, 21: reception antenna, 22: receiver, 23: A/D converter, 30: signal processor, 31: low-order compensating unit, 32: high-order phase linearizing unit, 33: high-order coherent integrating unit, 34: target detection unit, 35: low-order frequency domain converting unit, 36: high-order phase linearizing unit, 37: high-order coherent integrating unit, 38: target detection unit, 41: low-order compensating circuit, 42: high-order phase linearizing circuit, 43: high-order coherent integrating circuit, 44: target detection circuit, 45: low-order frequency domain converting circuit, 46: high-order phase linearizing circuit, 47: high-order coherent integrating circuit, 48: target detection circuit. 51: memory. 52: processor

1. A signal processor comprising processing circuitry
to acquire an input reception signal of a reflected wave from a target to be detected, and raise a sampling number of the input reception signal to power by using an order of a high-order component included in the input reception signal as a power index, and
to perform coherent integration of the reception signal having the sampling number raised to the power.

2. The signal processor according to claim 1, wherein the processing circuitry performs fast Fourier transform on the reception signal as the coherent integration of the reception signal having the sampling number raised to the power.

3. The signal processor according to claim 1, wherein the processing circuitry performs chirp Z-transform on the reception signal as the coherent integration of the reception signal having the sampling number raised to the power.

4. The signal processor according to claim 1, wherein the processing circuitry further performs to acquire a reception signal of a reflected wave from a target to be detected and perform suppression of a phase change of the reception signal due to a low-order component included in the reception signal, and
output a reception signal after phase change suppression as the input reception signal of the reflected wave.

5. The signal processor according to claim 1, wherein the processing circuitry acquires a reception signal of a reflected wave from a target to be detected, extract a plurality of partialized reception signals that are a set of some reception signals having sampling numbers different from each other from the reception signal, and perform conversion of the plurality of partialized reception signals into a plurality of frequency domain signals, respectively, and
output each of the plurality of frequency domain signals as the input reception signal of the reflected wave.

6. The signal processor according to claim 5, wherein the processing circuitry performs fast Fourier transform on each of the plurality of partialized reception signals as the conversion of the plurality of partialized reception signals into the plurality of frequency domain signals.

7. The signal processor according to claim 5, wherein the processing circuitry performs chirp Z-transform on each of the partialized reception signals as the conversion of the plurality of partialized reception signals into the plurality of frequency domain signals.

8. The signal processor according to claim 5, wherein the processing circuitry performs compensation for an acceleration component included in the reception signal of the reflected wave from the target to be detected using a provisionally set acceleration of the target, extracts a plurality of partialized reception signals from the reception signal after the compensation for the acceleration component, and converts the plurality of partialized reception signals into a plurality of frequency domain signals, respectively.

9. The signal processor according to claim 1, wherein the processing circuitry further performs to detect the target to be detected on a basis of signal intensity of the input reception signal after the coherent integration.

10. The signal processor according to claim 9, wherein the processing circuitry detects the target to be detected by performing CFAR (Constant False Alarm Rate) processing on signal intensity of the input reception signal after the coherent integration.

11. The signal processor according to claim 5, wherein the processing circuitry further performs to detect the target to be detected by performing CFAR processing on signal intensity of the input reception signal after the coherent integration, and
perform the CFAR processing after setting an evaluation region in each of a direction of a low-order component and a direction of a high-order component in the target to be detected.

12. A signal processing method comprising:
acquiring an input reception signal of a reflected wave from a target to be detected, and raising a sampling number of the input reception signal to power by using an order of a high-order component included in the input reception signal as a power index; and
performing coherent integration of the reception signal having the sampling number raised to the power.

13. A radar device comprising:
the signal processor according to claim 1; and
a receiver to receive the reflected wave from the target to be detected and output the input reception signal of the reflected wave to the signal processor.

14. The radar device according to claim 13, further comprising a transmitter to radiate an electromagnetic wave into the air, wherein
the receiver receives a reflected wave that is an electromagnetic wave after the electromagnetic wave is radiated from the transmitter and reflected by the target to be detected.
